(19) United States
(12) Patent Application Publication
(10) Pub. No.: US 2026/0044114 A1
(43) Pub. Date: Feb. 12, 2026

(54) LUMINOUS DISPLAY DEVICE FOR A TIMEPIECE, IN PARTICULAR FOR A WATCH, COMPRISING MEANS FOR IMPROVING THE VISUAL APPEARANCE OF THE TIMEPIECE

(71) Applicant: The Swatch Group Research and Development Ltd, Marin (CH)

(72) Inventor: Cyrille GERNEZ, Boudry (CH)

(73) Assignee: The Swatch Group Research and Development Ltd, Marin (CH)

(21) Appl. No.: 19/259,543

(22) Filed: Jul. 3, 2025

(30) Foreign Application Priority Data
Aug. 9, 2024 (EP) 24193808.3

(51) Int. Cl. G04B 19/30

(52) U.S. Cl. CPC G04B 19/305

(57) ABSTRACT

A luminous display device (1) configured to be fitted in a watch case, including a dial (2) with a dial body (20) having an upper face (21), and a hand (3, 4, 5) arranged above the dial (2) and mounted on a rotary arbor on the dial body (20). The hand has a layer forming a light guide (31, 41) to diffuse a luminous flux emitted by a lighting module (70) including an open cloisonné space (10) delimited by a back (26) formed by a dial rest (7) and by a peripheral wall (22) forming a screen made in one piece with the dial. The wall is positioned around the rotary arbor and extends above the dial body (20) over a defined height. The lighting module has a light source (6) arranged to emit a luminous flux towards the hand so as to illuminate the hand from below.

### CROSS REFERENCE TO RELATED APPLICATIONS

This application is claiming priority based on European Patent Application No. 24193808.3 filed on Aug. 9, 2024.

### TECHNICAL FIELD OF THE INVENTION

The invention relates to the field of displays for timepieces, in particular watches, and in particular the luminous display of such timepieces.

The invention relates more specifically to a luminous display device for a timepiece, said device comprising a dial comprising a dial body provided with a central hole and having an upper face, at least one hand arranged above the dial and mounted on a rotary arbor passing through the central hole of the dial body, the hand comprising a layer forming a light guide arranged to transmit all or part of a luminous flux emitted by a light source and at least one light source arranged to emit a luminous flux towards the hand so as to illuminate the latter from below, said light source being located below the upper face of the dial.

### TECHNOLOGICAL BACKGROUND

Patent application EP3845974 describes a luminous display device for a timepiece, comprising luminous display hands that are rotationally mobile around a rotational axis comprising a transparent light guide layer arranged to receive and transmit the luminous flux of a light source, a dial arranged below the display hands, and at least one stationary light source arranged to illuminate the hands from below. The stationary light source advantageously comprises LEDs arranged around the axis of the display hands.

To avoid or at least limit unwanted intense luminous points (hotspots) when viewed directly, the LEDs are positioned below the upper face of the dial.

Positioning the LEDs away from the display hands has the drawback of affecting the optical performance. Moreover, in the case of a simple design, that is, in a design in which, on one hand, the display device has no additional optical element between the LEDs and the display hands and, on the other hand, the distances and dimensions have been optimised to help improve the optical performance, the LEDs are visible to the user when the display device is observed at an observation angle greater than approximately 30 degrees relative to the rotational axis of the hands. FIG. 1 illustrates a depiction of the minimum angle from which the LEDs are visible. In this figure, references C, L and A refer to a dial, an LED and a display hand, respectively, with the reference a referring to the observation angle.

The invention aims to remedy these problems by providing a luminous display device for a timepiece, in particular for a watch, particularly a wristwatch, that avoids both hotspots and a direct view of the light source while allowing for optimal dimensioning and arrangement of the components of the display device.

The luminous display device according to the invention also aims to reduce light leakage.

The luminous display device according to the invention also aims to improve the optical performance.

The luminous display device according to the invention also aims to provide an improved visual appearance, both in terms of the optical appearance and the outer aesthetic appearance of the timepiece comprising such a display device.

### SUMMARY OF THE INVENTION

To this end, the invention provides a luminous display device configured to be fitted in a watch case, the display device comprising a dial comprising a dial body provided with a central hole and having an upper face, at least one hand arranged above the dial and mounted on a rotary arbor passing through the central hole in the dial body, the hand comprising a layer forming a light guide arranged to diffuse all or part of a luminous flux emitted by a lighting module comprising an open compartmentalized/partitioned/divided/cloisonné space delimited by a back formed by a dial rest and by a peripheral wall forming a screen made in one piece with said dial, said wall being positioned around the rotary arbor of the hand and extending above the dial body over a defined height, said lighting module comprising a light source located on the back of this space and being arranged to emit a luminous flux towards the hand so as to illuminate the latter from below.

“Defined height” means a height sufficient to mask the light source when the timepiece is observed by a user from any observation angle. The height will therefore be defined according to the dimensions of the specific components of the timepiece (dial, hand(s), light source) and to their position relative to each other. This height is also defined to provide a sufficient gap for ventilating the cloisonne space in order to regulate the temperature in this space, which can vary under the effect of any heat generated by the light source. This height defines a gap known as a ventilation gap between a top 24 of the wall 22 and an inner face 25 of the lower hand 4.

Thus, due to the presence of the peripheral wall defined above, the light source is concealed from view regardless of the observation angle from which the timepiece is observed, and directly visible hotspots are avoided. This makes it possible to provide a luminous display device with optimal dimensions and arrangement, without the drawbacks of the display devices in the prior art (hotspots, light leakage) and with optimised optical performance.

Advantageously, the back of the cloisonné space comprises a printed circuit board comprising the light source.

Advantageously, the light source comprises at least one electroluminescent diode and/or a VCSEL-type miniature laser source, for example.

Advantageously, the light source comprises a plurality of electroluminescent diodes and/or of miniature laser sources mounted on a printed circuit board and arranged to be distributed around the rotary arbors.

Advantageously, the peripheral wall is made in one piece with the dial body. In other words, the peripheral wall and the dial form a single piece.

Advantageously, the peripheral wall comprises a top that is dimensioned to be adjacent to the lower hand.

Advantageously, the peripheral wall has an inner face capable of reflecting the luminous flux emitted by the light source.

Advantageously, the peripheral wall is made of metal, of polymer or of ceramic.

Advantageously, the hand has a hand body comprising at least two layers, one of the layers being an opaque layer, the other layer being a transparent layer forming the light guide layer.

Advantageously, the light source comprises electroluminescent diodes and/or VCSEL-type miniature laser sources, for example, distributed around the rotary arbor of the hand.

Advantageously, the light source is vertically aligned with a transparent lower layer forming a light guide layer.

Advantageously, the cloisonné space opens onto a flat or substantially flat part of the lower hand.

Advantageously, the lower hand comprises a flat or substantially flat part of its inner face that completely masks/covers an opening in the cloisonné space.

Advantageously, the display device comprises plurality of hands respectively attached to respective rotary arbors mounted coaxially to each other so as to rotate around a common rotational axis, and in that at least the lower hand located closest to the dial has at least one orifice positioned in proximity to the rotary arbor so as to allow the luminous flux to pass through the lower hand so that at least part of the luminous flux is absorbed by the light guide layer on the hand located directly above the lower hand.

The invention also relates to a watch, such as a wristwatch, comprising a case comprising the display device as previously described.

### BRIEF DESCRIPTION OF THE FIGURES

Other features and advantages of the invention will be apparent from the following detailed description of the invention, provided by way of example and made with reference to the attached figures, in which:

FIG. 1 shows a partial schematic view of a luminous display device in the prior art, showing a depiction of the minimum angle from which the LEDs are visible;

FIG. 2 shows a partial cross-sectional view of a luminous display device for a watch according to an exemplary embodiment of the invention;

FIG. 3 shows a view of the dial fitted to the luminous display device in FIG. 2.

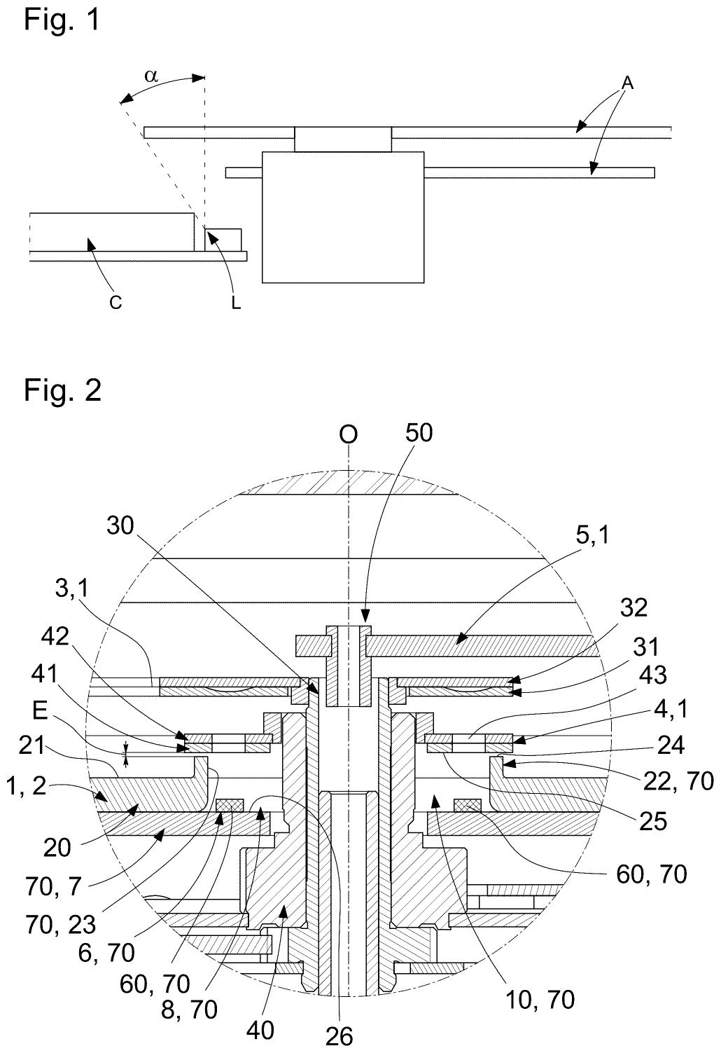

### DETAILED DESCRIPTION OF THE INVENTION

FIG. 2 shows a partial cross-sectional view of a luminous display device 1 designed to be fitted in a case of a timepiece such as a watch case.

In this context, the watch case therefore comprises this display device 1 comprising in particular a dial 2, hands 3, 4, 5 arranged above the dial 2 and a light source 6 arranged to emit a luminous flux towards the hands 3, 4, 5 so as to illuminate the latter from below. As shown, the light source 6 is located below the upper face of the dial 2.

More specifically, and conventionally, the dial 2 comprises a frame body 20 having an upper face 21 provided with indicators for the hours and optionally the minutes and/or seconds, for example in the form of numbers or any other predetermined symbols such as dots.

The hands 3, 4 and 5, of which there are three in the example shown, include an hour hand 3, a minute hand 4 and a second hand 5. The lower hand located closest to the dial 2 is the minute hand 4, the upper hand located directly above the lower hand is the hour hand 3 and the upper hand located furthest from the dial 2 is the second hand 5. Of course, it is clear that this an exemplary embodiment, and a different number of hands can be foreseen according to the desired functionality of the watch, as well as a different positioning of the hands relative to each other.

The hands 3, 4, 5 are securely attached to respective coaxial arbors 30, 40, 50. The arbors 30, 40, 50 are rotated by a horology movement (not shown) around a common rotational axis. The hands 3, 4, 5, which are arranged above the dial 2, form time display means together with the indicators on the upper face 21 of the dial body 20.

The hour hand 3 and the minute hand 4 respectively have a hand body comprising at least two superimposed layers 31, 32, 41, 42, the lower layer 31, 41 being a transparent layer forming a light guide layer arranged to transmit all or part of a luminous flux emitted by the light source 6, while the upper layer 32, 42 is an opaque layer, advantageously metallic. According to a particular configuration, an optical insulation layer can be provided between the light guide layer and the opaque layer (not shown).

The lower hand (in this example, the minute hand 4) advantageously comprises at least one orifice 43 located near the rotary arbor on which it is mounted so as to allow the luminous flux emitted by the light source 6 to pass through the lower hand via the orifice 40 so that at least part of the luminous flux is absorbed by the light guide layer 31 on the hand located directly above the lower hand. Of course, it is clear that this is an exemplary embodiment and that it can be foreseen that the hand located directly above the lower hand and optionally that the upper hand, that is, the hand furthest from the dial, is (are) provided with orifices located near the rotary arbors so that the lower hand, the hand directly above the lower hand and optionally the upper hand is (are) illuminated. In this case, these hands will advantageously comprise a layer forming a light guide.

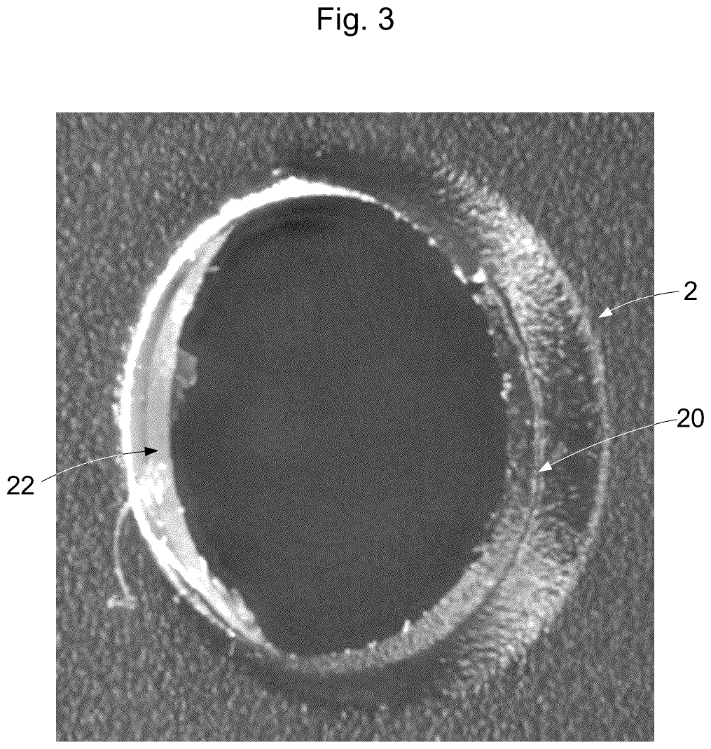

The dial 2, located below the hands 3, 4, 5, has a substantially flat dial body 20 provided with a central hole for the passage of the rotary arbors 30, 40, 50 on which the corresponding hands 3, 4, 5 are respectively mounted. The dial body comprises a peripheral wall 22 formed by a neck of the dial extending towards the hands, said wall 22 delimiting the central hole. FIG. 3 shows a view of the dial 2.

The dial 2 rests on an annular rest 7 which, in the example shown, has a central hole through which the coaxial arbors 30, 40, 50 pass. The central hole of the rest has a smaller diameter than that of the dial 2, so that a circular peripheral countersink 8 is provided on the inner side of the rest 7. “Inner side of the rest” refers to the side closest to the central hole of the rest 7. In the watch case, this rest 7 separates the dial 2 from the movement. In other words, the movement is arranged between this rest and a back on the case.

In this configuration, the dial body 20 is preferably made of metal using a manufacturing method that involves stamping and/or machining operations. As an alternative, this body 20 can be made of polymer using a manufacturing method that involves injection operations. As another alternative, it can be made of ceramic using a manufacturing method that involves pressing or sintering operations.

The light source 6 is located below the upper face 21 of the dial 2. In the example shown, it is positioned near the lower part of the dial 2, at the level of the circular countersink 8 formed between the coaxial arbors and the dial 2.

The light source 6 advantageously comprises electroluminescent diodes 60 mounted on a printed circuit board and arranged to be distributed around the rotary arbors. Advantageously, the printed circuit board is either carried by the dial rest 7 or incorporated therein.

According to the invention, the display device 1 comprises at least one element forming a screen positioned around the coaxial arbors 30, 40, 50 and extending above the dial body 20 over a defined height so as to delimit a cloisonne space in which the light source 6 is embedded. The light source 6 is thus masked regardless of the observation angle from which the watch is observed.

This cloisonné space 10 is an open cavity or a blind hole. It therefore comprises an opening arranged facing the inner face of the lower hand 4. In this configuration, the cloisonné space 10 opens onto a flat or substantially flat part of the lower hand 4. In other words, the lower hand 4 comprises a flat or substantially flat part on its inner face that completely masks or covers this opening in the cloisonné space 10.

In the example shown, the element forming the screen is formed by the peripheral wall 22, also referred to as the dial neck, this wall 22 preferably being made/formed when the dial body was manufactured. If the dial body is made of metal, this element forming a screen is produced/formed using stamping and/or machining operations on the zone of the dial body 20 around the edge of the central hole. These operations are carried out so as to create a raised layer of material sufficient to form a peripheral wall 22 extending over a height such that, when the dial 2 is fitted in the display device 1, the raised layer extending towards the hands 3, 4, 5 conceals the light source 6 while ensuring a gap E sufficient to ventilate the cloisonné space 10. Preferably, the peripheral wall 22 forming a screen extends to the vicinity of the lower hand. Advantageously, the height of the part of the peripheral wall comprised between the visible face of the dial 2 and an inner face of the lower hand 4 is comprised between 0.32 millimetres and 0.38 millimetres, and preferably on the order of 0.35 millimetres.

Thus, in addition to its function of masking the light source 6, the peripheral wall 22 of the dial 2 also acts as a reflector, as part of the luminous rays from the light source 6 can be reflected on the inner face 23 of this wall 22 back towards the hands 3, 4, 5. This has the advantage of improving the optical performance. Optical performance is even further improved by the fact that part of the luminous rays reflected by the hands can be reflected back towards the hands by the inner face of the wall 22. According to a variant embodiment in which the dial 2 is made of a material other than metal, it can be foreseen that the inner face 23 of the peripheral wall 22 will be plated with a reflective layer.

It should be noted that the light source is vertically aligned with the transparent lower layer 31 of the lower hand 4, forming a light guide layer.

Advantageously, the peripheral wall 22 is in the shape of a truncated cone and flares out towards the hands 3, 4 and 5. This has the advantage of redirecting the luminous rays reflecting off the inner face 23 of this wall 22 towards the hands 3, 4, 5.

In the example just described, the peripheral wall 22 is made in one piece with the dial body 20. In other words, this wall 22 is made of the same material as the dial 2. More specifically, it forms an integral part of the dial 2. The advantage of making an element that forms a screen by distorting the dial is that it limits the risk of a part coming apart in the event of a shock. Moreover, the resulting assembly (dial and screen-forming element) is more robust and fitting the parts is made easier, as no assembly is required.

It should be noted that in a variant embodiment, this peripheral wall 22 can be an attached or added part, for example tubular in shape, separate from the dial 2 and therefore from the dial body. In such a configuration, this part is inserted between the dial 2, or the dial body, and the light source 6. In this context, the material of which this insert is made is thus compatible with all of the materials, including mother-of-pearl, aventurine, glass and others.

Although particular embodiments have just been described in detail, the person skilled in the art will be aware that various modifications and alternatives thereto can be developed in light of the overall teaching provided by the present disclosure of the invention. Accordingly, the specific arrangements and/or methods described herein are intended by way of illustration only and are not intended to limit the scope of the invention.

### TERMINOLOGY

1—display device
2—dial
3, 4, 5—hour, minute, second hands, respectively
6—light source
7—dial rest
8—circular countersink
10—cloisonné space
20—dial body
21—upper face of the dial
22—peripheral wall of the cloisonné space
30, 40, 50—rotary arbors
31, 41—light guide layer
32, 42—opaque layer
60—electroluminescent diode
70—lighting module

1. A luminous display device (1) configured to be fitted in a watch case, the display device (1) comprising:
a dial (2) comprising a dial body (20) provided with a central hole and having an upper face (21);
at least one hand (3, 4, 5) arranged above the dial (2) and mounted on a rotary arbor passing through the central hole in the dial body (20),
the hand (3, 4) comprising a layer forming a light guide (31, 41) arranged to diffuse all or part of a luminous flux emitted by a lighting module (70) comprising an open cloisonné space (10) delimited by a back (26) formed by a dial rest (7) and by a peripheral wall (22) forming a screen made in one piece with said dial,
said wall (22) being positioned around the rotary arbor of the hand (3, 4, 5) and extending above the dial body (20) over a defined height, said lighting module (70) comprising a light source (6) located on the back (26) of the space (10) and being arranged to emit a luminous flux towards the hand (3, 4, 5) so as to illuminate the latter from below.

2. The luminous display device (1) according to claim 1, wherein the back (26) of the cloisonné space (10) comprises a printed circuit board comprising the light source.

3. The luminous display device (1) according to claim 1, wherein the light source (6) comprises at least one electroluminescent diode and/or a miniature laser source.

4. The luminous display device (1) according to claim 1, wherein the light source (6) comprises a plurality of electroluminescent diodes (60) and/or miniature laser sources mounted on a printed circuit board and arranged so as to be distributed around the rotary arbors.

5. The luminous display device (1) according to claim 1, wherein the peripheral wall (22) has an inner face (23) capable of reflecting the luminous flux emitted by the light source (6).

6. The luminous display device (1) according to claim 1, wherein the peripheral wall is made of metal, of polymer or of ceramic.

7. The luminous display device (1) according to claim 1, wherein said height defines a gap, referred to as the space ventilation gap (10), between a top (24) of the wall (22) and an inner face of the lower hand (4).

8. The luminous display device (1) according to claim 1, wherein the hand (3, 4, 5) has a hand body comprising at least two layers, one of the layers being an opaque layer (32, 42), the other layer being a transparent layer forming the light guide layer (31, 41).

9. The luminous display device (1) according to claim 1, wherein the light source is vertically aligned with a lower transparent layer (31) forming a light guide layer.

10. The luminous display device (1) according to claim 1, wherein the cloisonné space (10) opens onto a flat or substantially flat part of the lower hand (4).

11. The luminous display device (1) according to claim 1, wherein the lower hand (4) comprises a flat or substantially flat part of its inner face that completely masks/covers an opening in the cloisonné space (10).

12. The luminous display device (1) according to claim 1, further comprising a plurality of hands (3, 4, 5) respectively attached to respective rotary arbors (30, 40, 50) mounted coaxially to each other so as to rotate around a common rotational axis, and in that at least the lower hand (4) located closest to the dial (2) has at least one orifice positioned in proximity to the rotary arbor (40) so as to allow the luminous flux to pass through the lower hand (4) so that at least part of the luminous flux is absorbed by the light guide layer (31) on the hand (3) located directly above the lower hand (4).

13. A watch comprising a case comprising the luminous display device (1) according to claim 1.

14. The watch according to claim 13, the watch being a wristwatch.
